(19) United States
(12) Patent Application Publication
(10) Pub. No.: US 2010/0319653 A1
(43) Pub. Date: Dec. 23, 2010

(54) REDUCED FRICTION ROTARY COMBUSTION ENGINE

(75) Inventors: George Jerzy Zalewski, Scottsdale, AZ (US); Mario Scaini, Phoenix, AZ (US); Nathan Gibson, Tempe, AZ (US); Patrick Flynn, Phoenix, AZ (US)

Correspondence Address: HONEYWELL/IFL;Patent Services, 101 Columbia Road, P.O.Box 2245, Morristown, NJ, 07962-2245, US

(73) Assignee: HONEYWELL INTERNATIONAL INC., Morristown, NJ (US)

(21) Appl. No.: 12/488,088

(22) Filed: Jun. 19, 2009

(51) Int. Cl. F02B 53/08; F02B 53/04

(52) U.S. Cl. 123/213; 123/215

(57) ABSTRACT

An axial vane rotary combustion engine includes various performance improving features. These features include fluid film bearings that enable the vane assemblies to react large loads, a dual vane assembly configuration that share vane loads over two cylindrical bearing supports, a vane actuation mechanism that provides positive actuation even with cam surface tolerance variations, and various features to reduce friction to thereby improve efficiency and reduce heat generation.

### TECHNICAL FIELD

The present invention generally relates to rotary combustion engines, and more particularly to an axial vane rotary combustion engine that exhibits improved performance over presently known combustion engines of this type.

### BACKGROUND

Combustion engines are used to generate and supply power in myriad environments. For example, combustion engines have been used in various types of automobiles, aircraft, and watercraft, just to name a few. One particular type of combustion engine that has been developed is an axial vane rotary combustion engine. A typical axial vane rotary combustion engine, such as the one disclosed in U.S. Pat. No. 5,429,084, includes multiple vanes that are actuated by stationary cam surface. Adjacent vanes create a cavity that is compressed and expanded as it rotates relative to the cam surface. Fuel that is injected into each cavity via the stationary cam is combusted to generate power.

Although presently known axial vane rotary combustion engines, such as the one described above, are generally safe, reliable, and robust, these engines do suffer certain drawbacks. For example, such engines may not be configured to sufficiently react the loads generated from compression and combustion events while generating power at certain desired levels and/or may not exhibit adequate operational efficiency. The present invention addresses one or more of at least these drawbacks.

### BRIEF SUMMARY

In one exemplary embodiment, a rotary combustion engine includes an annular outer wall, a stator, a rotor, a plurality of vane openings, a plurality of actuator openings, a plurality of dual vane assemblies, and a plurality of vane actuators. The annular outer wall has an inner surface that defines a chamber. The stator is disposed within the chamber and includes at least two end walls. Each end wall has a vane cam surface and an actuator cam surface. The rotor is disposed within the chamber and is configured to rotate relative to the stator about a rotational axis. The vane openings extend through the rotor, with each vane opening disposed parallel to the rotational axis, and at least a portion of each vane opening having a cylindrical cross section. The actuator openings extend through the rotor, with each actuator opening disposed parallel to the rotational axis and radially inwardly of one of the plurality of vane openings. Each dual vane assembly is disposed within one of the plurality of vane openings, and includes first and second cylindrical sections, an actuator connection rod coupled between the first and second cylindrical section, a first substantially flat vane section extending from the first cylindrical section to a first vane end, and a second substantially flat vane section extending from the second cylindrical section to a second vane end. The first vane end and the second vane end each engage a vane cam surface. Each vane actuator is disposed within one of the plurality of actuator openings and is coupled to one of the dual vane assembly actuator connection rods. Each vane actuator has a first actuator end and a second actuator end, and the first actuator end and the second actuator end each engage an actuator cam surface.

In another exemplary embodiment, a rotary combustion engine includes an annular outer wall, a stator, a rotor, a plurality of vane openings, a plurality of actuator openings, a plurality of dual vane assemblies, and a plurality of vane actuators. The annular outer wall has an inner surface that defines a chamber. The stator is disposed within the chamber and includes at least two end walls. Each end wall has a vane cam surface and an actuator cam surface. The rotor is disposed within the chamber and is configured to rotate relative to the stator about a rotational axis. The vane openings extend through the rotor, with each vane opening disposed parallel to the rotational axis, and at least a portion of each vane opening having a cylindrical cross section. The actuator openings extend through the rotor, with each actuator opening disposed parallel to the rotational axis and radially inwardly of one of the plurality of vane openings. Each dual vane assembly is disposed within one of the plurality of vane openings and includes first and second substantially flat vane sections extending to first and second vane ends, respectively. The first vane end and the second vane end each engage a vane cam surface. Each vane actuator is disposed within one of the plurality of actuator openings, is coupled to one of the dual vane assemblies, and includes an actuating mechanism, a first cam follower, a second cam follower, a first hydraulic lifter, and a second hydraulic lifter. Each actuating mechanism is coupled to one of the dual vane assemblies and has a first end and a second end. The first and second cam followers each engage one of the actuator cam surfaces. The first hydraulic lifter is coupled between the actuating mechanism first end and the first cam follower, and the second hydraulic lifter is coupled between the actuating mechanism second end and the second cam follower.

In still another exemplary embodiment, a rotary combustion engine includes an annular outer wall, a stator, a rotor, a plurality of vane openings, a plurality of actuator openings, a plurality of dual vane assemblies, a plurality of first fluid film bearings, a plurality of second fluid film bearings, and a plurality of vane actuators. The annular outer wall has an inner surface that defines a chamber. The stator is disposed within the chamber and includes at least two end walls. Each end wall has a vane cam surface and an actuator cam surface. The rotor is disposed within the chamber and is configured to rotate relative to the stator about a rotational axis. The vane openings extend through the rotor, with each vane opening disposed parallel to the rotational axis, and at least a portion of each vane opening having a cylindrical cross section. The actuator openings extend through the rotor, with each actuator opening disposed parallel to the rotational axis and radially inwardly of one of the plurality of vane openings. Each dual vane assembly is disposed within one of the plurality of vane openings and includes first and second cylindrical sections, an actuator connection rod coupled between the first and second cylindrical section, a first substantially flat vane section extending from the first cylindrical section to a first vane end, and a second substantially flat vane section extending from the second cylindrical section to a second vane end. The first vane end and the second vane end each engaging a vane cam surface. Each first fluid film bearing is disposed between the rotor and a dual vane assembly first cylindrical section. Each second fluid film bearing is disposed between the rotor and a dual vane assembly second cylindrical section. Each vane actuator is disposed within one of the plurality of actuator openings, is coupled to one of the dual vane assembly actuator connection rods, and includes an actuating mechanism, a first cam follower, a second cam follower, a first hydraulic lifter, a second hydraulic lifter, a first roller, and a second roller. The actuating mechanism is coupled to one of the dual vane assemblies, and has a first end and a second end. The first hydraulic lifter is coupled between the actuating mechanism first end and the first cam follower, and the second hydraulic lifter is coupled between the actuating mechanism second end and the second cam follower. The first roller is rotationally coupled to the first cam follower and engages one of the actuator cam surfaces, and the second roller is rotationally coupled to the second cam follower and engages one of the actuator cam surfaces.

Furthermore, other desirable features and characteristics of the rotary combustion engine will become apparent from the subsequent detailed description and the appended claims, taken in conjunction with the accompanying drawings and the preceding background.

### BRIEF DESCRIPTION OF THE DRAWINGS

The present invention will hereinafter be described in conjunction with the following drawing figures, wherein like numerals denote like elements, and wherein:

FIG. 1 depicts a simplified, partially cut-away, isometric view of an axial vane rotary combustion engine according to an embodiment of the present invention;

FIG. 2 depicts a partial cross section view of a portion of the axial vane rotary combustion engine of FIG. 1;

FIG. 3 depicts an isometric view of a dual vane assembly that may be used to implement the axial vane rotary combustion engine of FIG. 1; and

FIG. 4 is an unfolded geometrically developed view of portions of the axial vane rotary combustion engine of FIG. 1, illustrating its operation.

### DETAILED DESCRIPTION

The following detailed description is merely exemplary in nature and is not intended to limit the invention or the application and uses of the invention. Furthermore, there is no intention to be bound by any theory presented in the preceding background or the following detailed description. In this regard, although the axial vane rotary combustion engine is described as being implemented as a diesel engine, it will be appreciated that it may also be readily implemented as a spark ignition engine.

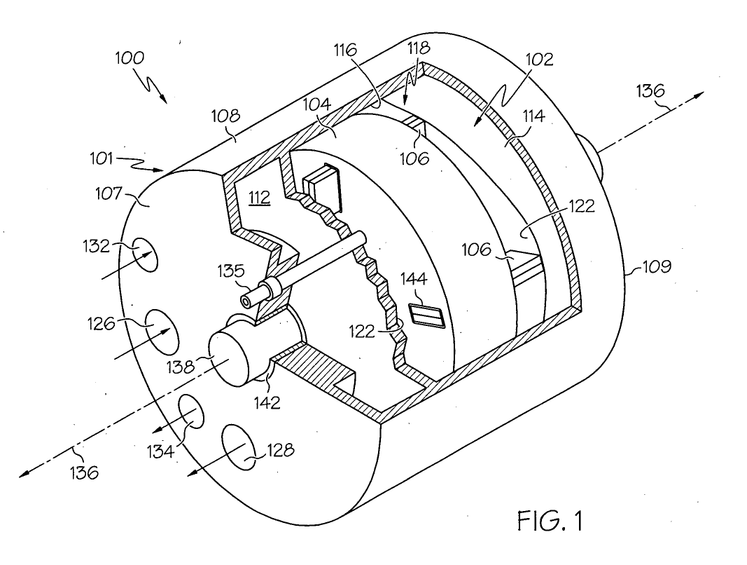

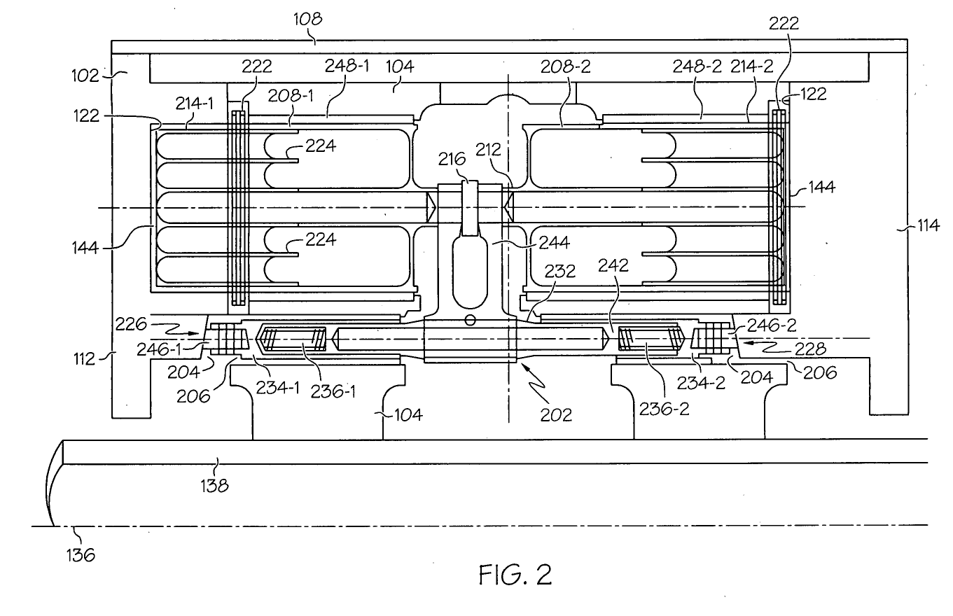

Referring first to FIGS. 1 and 2, a simplified, partially cut-away, isometric view of an exemplary axial vane rotary combustion engine 100, and a cross section view of a portion the exemplary engine 100, respectively, are depicted. The depicted engine 100 is implemented as a diesel engine, and thus does not include any spark plugs (or other combustion ignition devices). It will be appreciated, however, that the engine 100 could be readily implemented with suitable combustion ignition devices, if so desired. In any case, it is seen that the rotary combustion engine 100 includes a housing 101, a stator 102, a rotor 104, a plurality of dual vane assemblies 106, and a plurality of vane actuators 202 (not shown in FIG. 1). The depicted housing 101 is cylindrically shaped and includes an annular outer wall 108 and two end plates 107, 109.

The depicted stator 102 is mounted within the housing 101 and is also cylindrically shaped. The stator 102 is mounted to the end plates 107, 109 and includes two end walls 112, 114. The annular outer wall 108 has an inner surface 116 that, at least in part, defines a chamber 118 between the two stator end walls 112, 114. The end walls 112, 114 each have two cam surfaces. The cam surfaces may be integrally formed as part of the end walls 112, 114, or may be separately formed and then coupled to the end walls 112, 114. In either case, the two cam surfaces are referred to herein as a vane cam surface 122 and an actuator cam surface 204 (not shown in FIG. 1). It will be appreciated that the cam surfaces 122, 204 may be coated with a suitable material, such as a ceramic, to reduce friction and wear.

The end plates 107, 109 each have a plurality of openings formed therein. The openings include at least an air intake opening 126 and an exhaust opening 128, and in the depicted embodiment additionally include a coolant inlet opening 132 and a coolant discharge opening 134. Although these openings are visible on only one of the end plates 107 in FIG. 1, it will be appreciated that the other end plate 109 also preferably includes substantially identical openings. Though not depicted, coolant passageways may be formed in the stator 102 that fluidly connect the coolant inlet opening 132 and coolant discharge opening 134, to allow coolant to circulate through the stator 102, to thereby cool the engine 100. A fuel injector 135 (only one depicted) also extends through the each end plate 107, 109 and the stator 102. It will be appreciated that the engine 100 could include only a single fuel injector 135, or more than one fuel injector 135 per side, if needed or desired.

The rotor 104 is disposed within the chamber 118 and is configured to rotate relative to the stator 102 about a rotational axis 136. More specifically, the rotor 104, which is also preferably cylindrically shaped, is mounted on a shaft 138. The shaft 138 is in turn rotationally mounted on the stator 102 via one or more bearing assemblies 142 (only one visible), and is used to supply output power to a load. Thus, the shaft 138 may be appropriately keyed or splined to couple to a non-illustrated component. It will be appreciated that the rotor 104 may be variously formed. For example, it may be formed as a hollow, unitary casting, or from a plurality of substantially identical castings. The rotor 104 may additionally be formed as a substantially solid piece.

No matter its shape or its specific manner of construction, the rotor 104 also includes two sets of openings. One set of openings are referred to herein as vane openings 144, and the other set of openings are referred to herein as actuator openings 206 (not visible in FIG. 1). The vane openings 144 extend through the rotor 104, and are disposed parallel to the rotational axis 136. Moreover, for reasons that will become apparent, at least a portion of each vane opening 144 has a cylindrical cross section. The actuator openings 206, which are each disposed radially inwardly of one of the vane openings 144, also extend through the rotor 104, and are also disposed parallel to the rotational axis 136. Preferably, the actuator openings 206 also implement fluid film bearings, which eliminate vane sliding friction and help react loads exerted on the vane actuators 208.

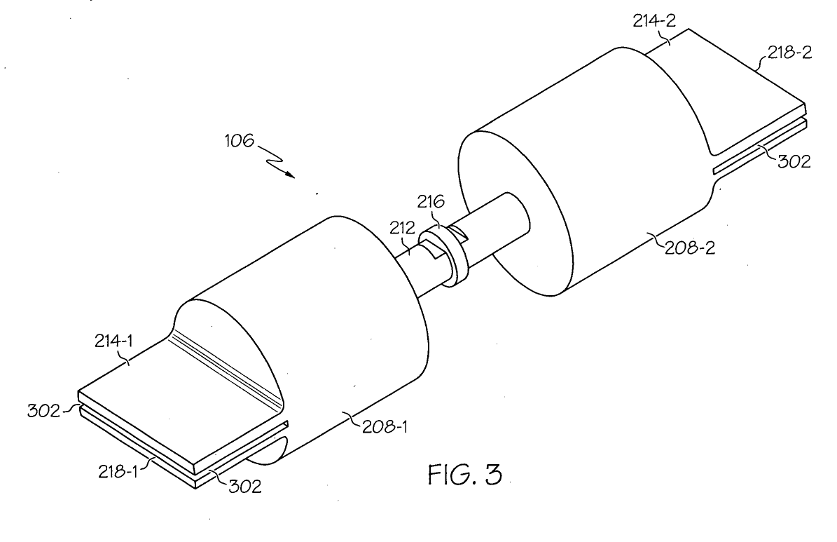

Each dual vane assembly 106 is disposed within one of the plurality of vane openings 144 and, as shown more clearly in FIGS. 2 and 3, each includes first and second cylindrical sections 208 (e.g., 208-1, 208-2), an actuator connection rod 212, and first and second substantially flat vane sections 214 (214-1, 214-2). The actuator connection rod 212 is coupled between the first and second cylindrical section 208 and has an actuator connection stub 216 extending therefrom. The first substantially flat vane section 214-1 extends from the first cylindrical section 208-1 to a first vane end 218-1, and the second substantially flat vane section 214-2 extends from the second cylindrical section 208-2 to a second vane end 218-2.

As is shown most clearly in FIG. 2, the first and second substantially flat vane sections 214 each extend through a face seal 222, and the first and second vane ends 218 each engage a vane cam surface 122. As FIG. 2 also depicts, the first and second cylindrical sections 208 and the first and second substantially flat vane sections 214 are each at least partially hollow. This is done so as to reduce the overall weight of the dual vane assemblies 106. In addition, to increase the overall strength and stiffness, stiffening ribs 224 are preferably included at least within the first and second substantially flat vane sections 214.

Each vane actuator 202 is disposed within one of the plurality of actuator openings 206 and is coupled to one of the dual vane assembly actuator connection rods 212. Each vane actuator 202 has a first actuator end 226 that engages an actuator cam surface 204, and a second actuator end 228 that engages an opposed actuator cam surface 204. More specifically, the each vane actuator 202 includes an actuating mechanism 232, first and second cam followers 234 (234-1, 234-2), and first and second hydraulic lifters 236 (236-1, 236-2). The actuating mechanism 232 is coupled to a dual vane assembly 106 and includes a first end 238 and a second end 242. Although the manner in which each actuating mechanism 232 may be coupled to a dual vane assembly 106 may vary, in the depicted embodiment each actuating mechanism 232 includes a forked engagement mechanism 244 that engages one of the actuator connection stubs 216, and provides anti-rotation of the dual vane assembly 106.

The first cam follower 234-1 engages one of the actuator cam surfaces 204, and the second cam follower 234-2 engages the opposing actuator cam surface 204. Preferably, the first and second cam followers 234-1, 234-2 engage the associated actuator cam surfaces 204 via a first roller 246-1 and a second roller 246-2, respectively, that are rotationally coupled thereto. The first and second rollers 246-1, 246-2 may be variously implemented, but are preferably implemented using tapered rollers. The tapered rollers 246-1, 246-2 help eliminate potential skidding between the actuator cam surfaces 204 and the vane actuator 202.

The first hydraulic lifter 236-1 is coupled between the actuating mechanism first end 238 and the first cam follower 234-1. Similarly, the second hydraulic lifter 236-2 is coupled between the actuating mechanism second end 242 and the second cam follower 234-2. The hydraulic lifters 236-1, 236-2, together with the tapered rollers 246-1, 246-2, provide positive actuation of each dual vane assembly 106, while allowing the vane actuators 202 the ability to negotiate potential actuator cam surface 204 variations.

In addition to the above, the rotor 104 also includes a plurality of seals and a plurality of fluid film bearings. In particular, and with continued reference to FIG. 2, the rotor 104 includes a plurality of face seals 222. Each face seal 222 is disposed within one of the vane openings 144 and surrounds, and slidably and sealingly engages, one of the substantially flat vane sections 214-1, 214-2. Although the face seals 222 may be variously configured, in the depicted embodiment each face seal 222 is an assembly comprised of multiples seals with overlapping characteristics.

Referring briefly to FIG. 3, it is seen that the first and second substantially flat vane sections 214-1, 214-2, at least in the depicted embodiment, each include seal grooves 302. More specifically, a seal groove 302 is formed in opposing sides of each of the first and second substantially flat vane sections 214-1, 214-2. A non-illustrated vane side seal is disposed within each seal groove 302. It will be appreciated that in some embodiments the vane side seals may also extend across the first and second vane ends 218-1, 218-2 and function as, what is referred to herein as, apex seals. In such embodiments, and as FIG. 3 further depicts, the seal groove 302 extends across the first and second vane ends 218-1, 218-2. In other embodiments, separate apex seals may be used. As will be described in more detail further below, as the dual vane assemblies 106 slide back and forth within the rotor 104, each of the substantially flat vane sections 214-1, 214-2 slide relative to its associated face seal 222, and each of the vane side seals and apex seals sweep the static structure.

Returning once again to FIG. 2, the plurality of fluid film bearings include a plurality of first fluid film bearings 248-1 and a plurality of second fluid film bearings 248-2. The first fluid film bearings 248-1 are disposed, one each, between the rotor 104 and each dual vane assembly first cylindrical section 208-1, and the second fluid film bearings 248-2 are disposed, one each, between the rotor 104 and each dual vane assembly second cylindrical section 208-2. Hence, the first and second cylindrical sections 208 also function as fluid film bearing supports.

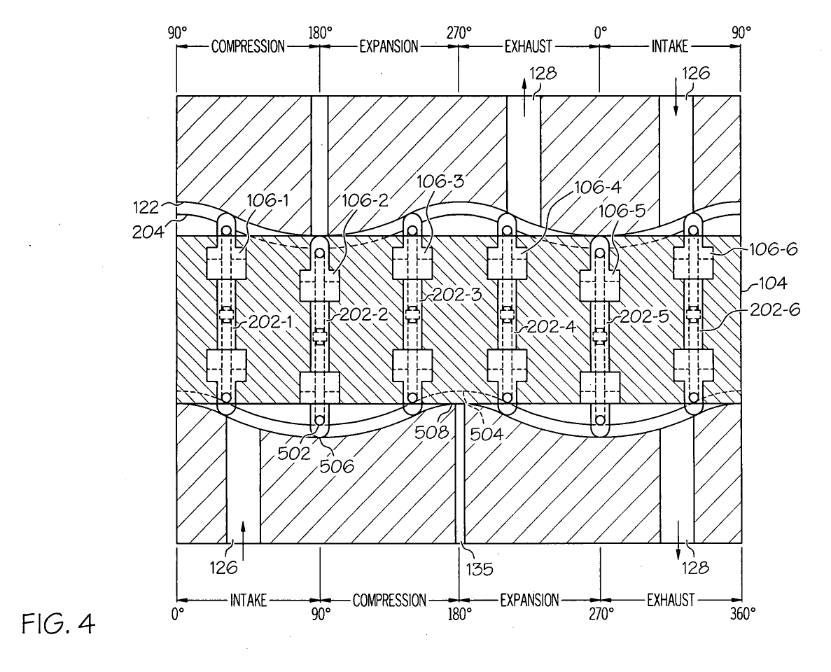

Turning now to FIG. 4, the operation of the axial vane rotary combustion engine 100 will be described. Before doing so, it is noted that the depicted engine 100 includes six dual vane assemblies 106 (e.g., 106-1, 106-2, 106-3, 106-4, 106-5, 106-6) and thus six vane actuators 202 (e.g., 202-1, 202-2, 202-3, 202-4, 202-5, 202-6). It will be appreciated that this number of dual vane assemblies 106 and concomitant vane actuators 202 is merely exemplary, and that in other embodiments the engine 100 may be implemented with more or less than this number. Indeed, in one particular preferred embodiment, the engine 100 is implemented with twelve dual vane assemblies 106 and twelve vane actuators 202. It will additionally be appreciated that the top and bottom halves of the engine 100, from the point of view of FIG. 4, operate independently and identically. Therefore, for ease of explanation, the operation of only the bottom half of the engine 100 will be described.

From the point of view of FIG. 4, the rotor 104 is assumed to “rotate” to the right, and engine operation is described with reference to degrees-of-rotation about vane cam surface 122 and actuator cam surface 204. At the point in time depicted in FIG. 4, the first dual vane assembly 106-1 and first vane actuator 202-1 are at approximately 30 degrees-of-rotation, just prior to the intake port 126. As the first dual vane assembly 106-1 and first vane actuator 202-1 move to the right, air drawn into intake port 126 is trapped between the first dual vane assembly 106-1 and the second dual vane assembly 106-2.

The second dual vane assembly 106-2 and the third dual vane assembly 106-3 are at approximately 90 degrees-of-rotation and 150 degrees-of-rotation, respectively, at the beginning of a compression stroke. As the rotor 104 rotates, the second and third vane actuators 202-2, 202-3 are moved from the low portion 502 of the actuator cam surface 204 to the high portion 504 of the actuator cam surface 204. The second and third vane actuators 202-2, 202-3 thus move the second and third dual vane assemblies 106-2, 106-3 from the low portion 506 of the vane cam surface 122 to the high portion 508 of the vane cam surface 122. The air that is between the second dual vane assembly 106-2 and the third dual vane assembly 106-3 is compressed due to the decreasing volume between these dual vane assemblies 106-2, 106-3. It is noted that from the viewpoint of FIG. 4, the low portions 502, 506 of the actuator cam surfaces 204 and the vane cam surfaces 122 are further from the rotor 104 than the concomitant high cam portions 504, 506 of these cam surfaces 204, 122.

The air between two adjacent dual vane assemblies 106 is fully compressed at the positions that correspond to the third and fourth dual vane assemblies 106-3, 106-4. The third dual vane assembly 106-3, as noted above, is at 150 degrees-of-rotation while the fourth dual vane assembly 106-4 is at 210 degrees-of-rotation. The fuel, which is supplied via the fuel injector 135, is combusted at this position or, if implemented as a spark ignition engine, the fuel may be ignited when these dual vane assemblies 106-3, 106-4 are just past the depicted positions. For example, when the third dual vane assembly 106-3 is rotated, via its vane actuator 208-3, to about 180 degrees-of-rotation.

The expansion stroke of the engine 100, during which the combusted fuel/air mixture expands, occurs as the dual vane assemblies 106 move to the position of the fifth dual vane assembly 106-5. The exhaust stroke of the engine 100 also begins at the position of the fifth dual vane assembly 106-5, which is 270 degrees-of-rotation. At this position, exhaust gases are disposed between the fifth and sixth dual vane assemblies 106-5, 106-6. The exhaust gases are discharged out the exhaust port 128 as the fifth vane actuator 202-5 rotates the fifth dual vane assembly 106-5 to the right (from the point of view of FIG. 4). As may be appreciated, the upper half of the engine 100 operates in a similar manner, but the positions of the various strokes are staggered and follow the sequence of compression stroke, expansion stroke, exhaust stroke and intake stroke from left to right from the point of view of FIG. 4.

The axial vane rotary combustion engine 100 described herein provides improved performance over similar, presently known engines. This improved performance is provided via and improved configuration that results in a significant reduction in friction, with concomitant reduction in power loss and improved efficiency. These improvements are attributable to the configuration of the dual vane assemblies, which provides stiffness and contributes to load sharing and reduced deflections. The dual vane assembly shape reduces deflections and stress levels. The dual fluid film bearing arrangement supports large centrifugal loads and also helps reduce deflections. The vane actuator configuration results in proper positioning even with variations in cam profile tolerances.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A rotary combustion engine, comprising:
an annular outer wall having an inner surface that defines a chamber;
a stator disposed within the chamber and including at least two end walls, each end wall having a vane cam surface and an actuator cam surface;
a rotor disposed within the chamber and configured to rotate relative to the stator about a rotational axis;
a plurality of vane openings extending through the rotor, each vane opening disposed parallel to the rotational axis, at least a portion of each vane opening having a cylindrical cross section;
a plurality of actuator openings extending through the rotor, each actuator opening disposed parallel to the rotational axis and radially inwardly of one of the plurality of vane openings;
a plurality of dual vane assemblies, each dual vane assembly disposed within one of the plurality of vane openings and including first and second cylindrical sections, an actuator connection rod coupled between the first and second cylindrical section, a first substantially flat vane section extending from the first cylindrical section to a first vane end, and a second substantially flat vane section extending from the second cylindrical section to a second vane end, the first vane end and the second vane end each engaging a vane cam surface; and
a plurality of vane actuators, each vane actuator disposed within one of the plurality of actuator openings and coupled to one of the dual vane assembly actuator connection rods, each vane actuator having a first actuator end and a second actuator end, the first actuator end and the second actuator end each engaging an actuator cam surface.

2. The engine of claim 1, wherein each vane actuator comprises:
an actuating mechanism coupled to one of the dual vane assemblies, the actuating mechanism having a first end and a second end;
a first cam follower and engaging one of the actuator cam surfaces;
a second cam follower engaging one of the actuator cam surfaces;
a first hydraulic lifter coupled between the actuating mechanism first end and the first cam follower; and
a second hydraulic lifter coupled between the actuating mechanism second end and the second cam follower.

3. The engine of claim 2, wherein each vane actuator further comprises:
a first roller rotationally coupled to the first cam follower and engaging one of the actuator cam surfaces; and
a second roller rotationally coupled to the second cam follower and engaging one of the actuator cam surfaces.

4. The engine of claim 3, wherein the first and second rollers are each tapered rollers.

5. The engine of claim 1, wherein:
each dual vane assembly further comprises an actuator connection stub extending from the actuator connection rod; and
each vane actuator comprises a forked engagement mechanism that engages one of the actuator connection stubs.

6. The engine of claim 1, further comprising:
a plurality of face seals, each face seal disposed within one of the vane openings and surrounding, and slidably and sealingly engaging, one of the first or second substantially flat vane sections.

7. The engine of claim 1, wherein the first and second substantially flat vane sections each have a plurality of seal grooves formed therein for receiving a seal.

8. The engine of claim 1, wherein the first and second cylindrical sections and the first and second substantially flat vane sections are each at least partially hollow.

9. The engine of claim 8, further comprising:
a plurality of stiffening ribs formed within the first and second cylindrical sections and the first and second substantially flat vane sections that are at least partially hollow at least partially hollow.

10. The engine of claim 1, further comprising:
a plurality of first fluid film bearings disposed between the rotor and each dual vane assembly first cylindrical section; and
a plurality second fluid film bearings disposed between the rotor and each dual vane assembly second cylindrical section.

11. A rotary combustion engine, comprising:
an annular outer wall having an inner surface that defines a chamber;
a stator disposed within the chamber and including at least two end walls, each end wall having a vane cam surface and an actuator cam surface;
a rotor disposed within the chamber and configured to rotate relative to the stator about a rotational axis;
a plurality of vane openings extending through the rotor, each vane opening disposed parallel to the rotational axis, at least a portion of each vane opening having a cylindrical cross section;
a plurality of actuator openings extending through the rotor, each actuator opening disposed parallel to the rotational axis and radially inwardly of one of the plurality of vane openings;
a plurality of dual vane assemblies, each dual vane assembly disposed within one of the plurality of vane openings and including first and second substantially flat vane sections extending to first and second vane ends, respectively, the first vane end and the second vane end each engaging a vane cam surface; and
a plurality of vane actuators, each vane actuator disposed within one of the plurality of actuator openings and coupled to one of the dual vane assemblies, each vane actuator comprising:
an actuating mechanism coupled to one of the dual vane assemblies, the actuating mechanism having a first end and a second end,
a first cam follower engaging one of the actuator cam surfaces,
a second cam follower engaging one of the actuator cam surfaces,
a first hydraulic lifter coupled between the actuating mechanism first end and the first cam follower, and
a second hydraulic lifter coupled between the actuating mechanism second end and the second cam follower.

12. The engine of claim 11, wherein:
each dual vane assembly further comprises first and second cylindrical sections and an actuator connection rod coupled between the first and second cylindrical section;
the first substantially flat vane section extends from the first cylindrical section to the first vane end; and
the second substantially flat vane section extends from the second cylindrical section to the second vane end.

13. The engine of claim 12, wherein:
each dual vane assembly further comprises an actuator connection stub extending from the actuator connection rod; and
each vane actuator comprises a forked engagement mechanism that engages one of the actuator connection stubs.

14. The engine of claim 11, wherein each vane actuator further comprises:
a first tapered roller rotationally coupled to the first cam follower and engaging one of the actuator cam surfaces; and
a second tapered roller rotationally coupled to the second cam follower and engaging one of the actuator cam surfaces.

15. The engine of claim 11, further comprising:
a plurality of face seals, each face seal disposed within one of the vane openings and surrounding, and slidably and sealingly engaging, one of the first or second substantially flat vane sections.

16. The engine of claim 11, wherein the first and second substantially flat vane sections each having a plurality of seal grooves formed therein for receiving a seal.

17. The engine of claim 1, further comprising:
a plurality of first fluid film bearings disposed between the rotor and each dual vane assembly first cylindrical section; and
a plurality of second fluid film bearings disposed between the rotor and each dual vane assembly second cylindrical section.

18. A rotary combustion engine, comprising:
an annular outer wall having an inner surface that defines a chamber;
a stator disposed within the chamber and including at least two end walls, each end wall having a vane cam surface and an actuator cam surface;
a rotor disposed within the chamber and configured to rotate relative to the stator about a rotational axis;
a plurality of vane openings extending through the rotor, each vane opening disposed parallel to the rotational axis, at least a portion of each vane opening having a cylindrical cross section;
a plurality of actuator openings extending through the rotor, each actuator opening disposed parallel to the rotational axis and radially inwardly of one of the plurality of vane openings;
a plurality of dual vane assemblies, each dual vane assembly disposed within one of the plurality of vane openings and including first and second cylindrical sections, an actuator connection rod coupled between the first and second cylindrical section, a first substantially flat vane section extending from the first cylindrical section to a first vane end, and a second substantially flat vane section extending from the second cylindrical section to a second vane end, the first vane end and the second vane end each engaging a vane cam surface;
a plurality of first fluid film bearings disposed between the rotor and each dual vane assembly first cylindrical section;
a plurality of second fluid film bearings disposed between the rotor and each dual vane assembly second cylindrical section; and
a plurality of vane actuators, each vane actuator disposed within one of the plurality of actuator openings and coupled to one of the dual vane assembly actuator connection rods, each vane actuator comprising:
an actuating mechanism coupled to one of the dual vane assemblies, the actuating mechanism having a first end and a second end,
a first cam follower,
a second cam follower,
a first hydraulic lifter coupled between the actuating mechanism first end and the first cam follower,
a second hydraulic lifter coupled between the actuating mechanism second end and the second cam follower,
a first roller rotationally coupled to the first cam follower and engaging one of the actuator cam surfaces, and
a second roller rotationally coupled to the second cam follower and engaging one of the actuator cam surfaces.

19. The engine of claim 18, wherein:
the first and second rollers are each tapered rollers,
each dual vane assembly further comprises an actuator connection stub extending from the actuator connection rod; and
each vane actuator comprises a forked engagement mechanism that engages one of the actuator connection stubs.

20. The engine of claim 18, further comprising:
a plurality of face seals, each face seal disposed within one of the vane openings and surrounding, and slidably and sealingly engaging, one of the first or second substantially flat vane sections.
